(19) United States
(12) Patent Application Publication
(10) Pub. No.: US 2007/0132896 A1
(43) Pub. Date: Jun. 14, 2007

(54) Liquid crystal display

(75) Inventors: Kon-Ho Lee, Seoul (KR); Kil-Soo Choi, Suwon-si (KR); Jin-Oh Kwag, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/543,709

(22) Filed: Oct. 3, 2006

(30) Foreign Application Priority Data
Dec. 13, 2005 (KR) 10-2005-0122374

(51) Int. Cl. G02F 1/13

(52) U.S. Cl. 349/2

(57) ABSTRACT

A liquid crystal display and a driving method for the same are provided. More particularly, a dual liquid crystal display and a driving method for the same are provided. The liquid crystal display includes a liquid crystal panel assembly that is provided with a first display area and a second display area that are positioned at opposite sides to each other, and a memory that stores image data from the outside in a matrix shape. The memory includes a first region for storing data that are displayed in the first display area and a second region for storing data that are displayed in the second display area, among the image data, and data that are last input in one row unit are first output among the data that are stored in the first region and data that are first input are first output among the data that are stored in the second region. In this way, an image that is displayed in particularly sub-display area among main display area and sub-display area that are formed on one display panel can be displayed in a source format rather than an inversion format.

### CROSS-REFERENCE TO RELATED APPLICATION

This application claims priority to and the benefit of Korean Patent Application No. 10-2005-0122374 filed in the Korean Intellectual Property Office on Dec. 13, 2005, the contents of which are incorporated herein by reference.

### FIELD OF THE INVENTION

The present invention relates to a liquid crystal display and a driving method for the same.

### DESCRIPTION OF THE RELATED ART

A general liquid crystal display (LCD) includes two display panels that are provided with a plurality of pixel electrodes and a common electrode between which is a liquid crystal layer having dielectric anisotropy. One of the panels typically includes a matrix of pixel electrodes, each connected to a switching element such as a thin film transistor (TFT), sequentially receives data voltages row by row. A common electrode is formed over an entire surface of the other of the panels. The data voltages produce a varying electric field in the liquid crystal layer that produces a corresponding variance in the transmittance of light passing through the liquid crystal layer, thereby producing an image corresponding to the data voltages. The polarity of the data voltage is inverted on successive frames on a row or a pixel basis to prevent a unidirectional electric field from being applied to the liquid crystal layer for too long a time.

In small and medium display devices such as used for mobile phones, a so-called dual display device having a display panel at each of the inside and outside thereof has been actively developed. A main display panel is mounted on the inside and a sub-display panel is mounted on the outside with a flexible printed circuit film (FPC) providing an input driving signal.

Because main display area is displayed on a front surface and a sub-display area is displayed on a rear surface, an image (hereinafter, referred to as a “subsidiary image”) displayed in sub-display area and an image (hereinafter, referred to as a “main image”) displayed in main display area, tend to generate an inverted image having mirror symmetry.

### SUMMARY OF THE INVENTION

The present invention provides a liquid crystal display capable of displaying a subsidiary image without image inversion. An exemplary embodiment of the present invention provides a liquid crystal panel assembly having a first display area and a second display area; a memory that stores a matrix of image data for the first display area and for the second display area, so that of the data that are stored in the first region, the last input in one row are first output and so that of the data that stored in the second region, the data that are first input are first output.

Another embodiment of the present invention provides a driving method for a liquid crystal display including a liquid crystal panel assembly that is provided with a first display area and a second display area opposite each other, and a memory that stores a matrix of image data having a first region for storing data that are displayed in the first display area and a second region for storing data that are displayed in the second display area; writing the image data in the memory; first outputting data that are last input in one row unit among the data that are stored in the first region; and first outputting data that are first input among the data that are stored in the second region.

### BRIEF DESCRIPTION OF THE DRAWINGS

The accompanying drawings briefly described below illustrate exemplary embodiments of the present invention, and together with the description, serve to explain the principles of the present invention.

FIG. 1 is a block diagram of a liquid crystal display according to an exemplary embodiment of the present invention.

FIG. 2 is an equivalent circuit diagram of one pixel of the liquid crystal display according to an exemplary embodiment of the present invention.

FIGS. 3A to 3C are a front view, a rear view, and a side view, respectively, of the liquid crystal display according to an exemplary embodiment of the present invention.

FIG. 4 is a cross-sectional view of the liquid crystal display taken along line IV-IV′ of FIG. 3A.

FIG. 5 is a view illustrating transmission and reflection of light in the liquid crystal display according to an exemplary embodiment of the present invention.

FIG. 6 is a view schematically illustrating a gate line in the liquid crystal display shown in FIG.3A.

FIG. 7 is a view illustrating a display direction in the liquid crystal display according to an exemplary embodiment of the present invention.

FIG. 8 is a view illustrating a write direction in a memory of the liquid crystal display according to an exemplary embodiment of the present invention.

FIG. 9 is a view illustrating a read direction in a memory of the liquid crystal display according to an exemplary embodiment of the present invention.

FIG. 10 is a view illustrating an image that is displayed in the liquid crystal display according to an exemplary embodiment of the present invention.

FIG. 11 is a view illustrating an image that is displayed in a sub-display area of the liquid crystal display in the images that are shown in FIG. 10.

FIGS. 12A and 12B are views illustrating a read direction and a write direction in a memory of a liquid crystal display according to another exemplary embodiment of the present invention.

### DETAILED DESCRIPTION OF THE EMBODIMENTS

The present invention will now be described more fully hereinafter with reference to the accompanying drawings, in which preferred embodiments of the invention are shown. In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

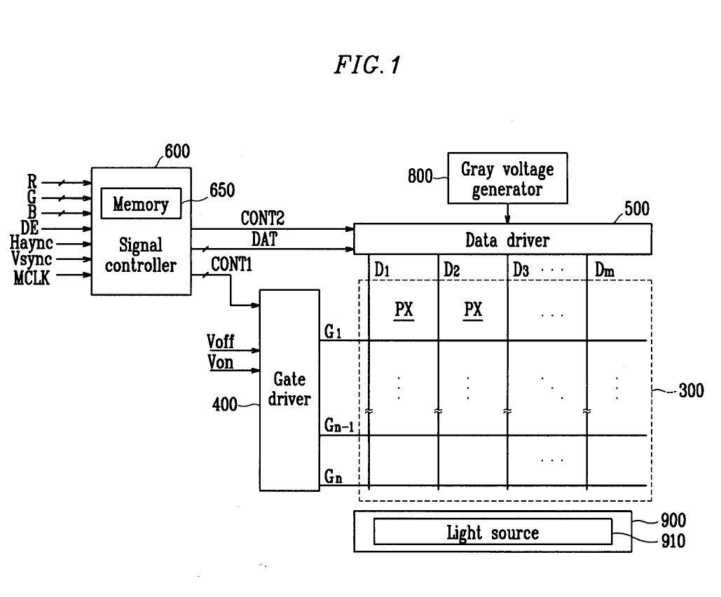

As shown in FIG. 1, the liquid crystal display according to an exemplary embodiment of the present invention includes a liquid crystal panel assembly 300, a gate driver 400 and a data driver 500 that are connected thereto, a gray voltage generator 800 that is connected to the data driver 500, a signal controller 600 that controls them, and a backlight unit 900 that provides light to the liquid crystal panel assembly 300.

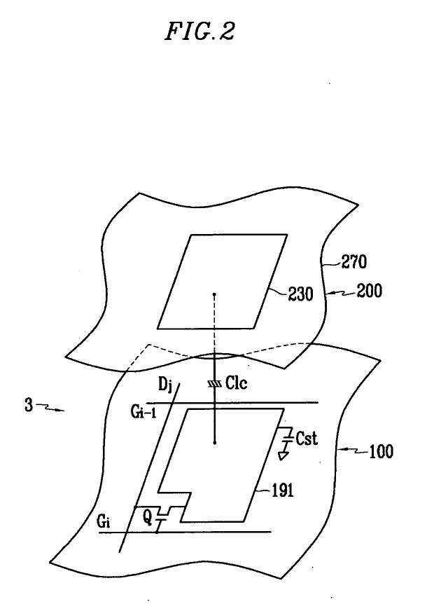

The liquid crystal panel assembly 300 includes a plurality of signal lines G₁ to Gₙ and D₁ to Dₘ, and a matrix of pixels PX that are connected thereto. The liquid crystal panel assembly 300 includes lower and upper panels 100 and 200 that are opposite to each other, and a liquid crystal layer 3 that is interposed therebetween, as shown in FIG. 2.

Signal lines G₁ to Gₙ and D₁ to Dₘ include a plurality of gate lines G₁ to Gₙ that transfer a gate signal (or referred to as a “scanning signal”) and a plurality of data lines D₁ to Dₘ that transfer a data signal. Gate lines G₁ to Gₙ extend in approximately a row direction and are almost parallel to each other, and the data lines D₁ to Dₘ extend in approximately a column direction and are almost parallel to each other.

Each pixel PX, for example a pixel PX that is connected to an ith (i=1, 2, n) gate line Gᵢ and a jth (0=1, 2, m) data line Dⱼ, includes a switching element Q that is connected to signal lines Gᵢ and Dⱼ and a storage capacitor Cst and a liquid crystal capacitor Clc that are connected thereto. The storage capacitor Cst may be omitted, as needed.

Switching element Q such as a thin film transistor is provided in lower panel 100 and is a three terminal element. The control terminal and the input terminal thereof are connected to gate lines G₁ to Gₙ and the data lines D₁ to Dₘ, respectively, and the output terminal thereof is connected to the liquid crystal capacitor Clc and the storage capacitor Cst.

Liquid crystal capacitor Clc has a pixel electrode 1910n lower panel 100 and a common electrode 270 on upper panel 200 as two terminals so that the liquid crystal layer 3 between two electrodes 191 and 270 functions as a dielectric material. Pixel electrode 191 is connected to switching element Q and common electrode 270 is formed on an entire surface of upper panel 200 and receives a common voltage Vcom. Unlike the case of FIG. 2, the common electrode 270 may be provided in lower panel 100, and at this time, at least one of the two electrodes 191 and 270 may be formed in a line shape or a bar shape.

Storage capacitor Cst functions as an auxilliary to liquid crystal capacitor Clc and is formed with the overlap of a separate signal line (not shown) and pixel electrode 191 that is provided in lower panel 100 with an insulator interposed therebetween. A predetermined voltage, such as a common voltage Vcom, is applied to the separate signal line.

Color may be displayed by allowing each pixel PX to inherently display one of the primary colors (spatial division) or to sequentially alternately display each of the primary colors (temporal division). A desired color is recognized as the spatial and temporal sum of the primary colors. An example of a set of the primary colors includes red, green, and blue. FIG. 2 shows, as an example of spatial division, that each pixel PX is provided with a color filter 230 for displaying one of the primary colors in a region of upper panel 200 corresponding to pixel electrode 191. Unlike the case of FIG. 2, the color filter 230 may be formed on or under pixel electrode 1910f lower panel 100.

A backlight unit 900 includes a light source 910 including a plurality of lamps (not shown) that is mounted in a lower part of the liquid crystal panel assembly 300. Small and medium liquid crystal displays use a light emitting diode LED, etc., as a lamp, and the lamp may be an edge type that is disposed in a lower edge of the liquid crystal panel assembly 300 and that has a light guide.

A polarizer (not shown) for polarizing light from the light source 910 is attached to an outside surface of two display panels 100 and 200 of the liquid crystal panel assembly 300.

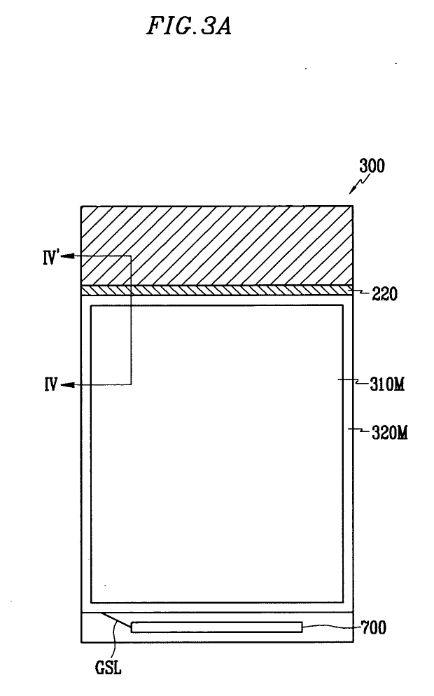

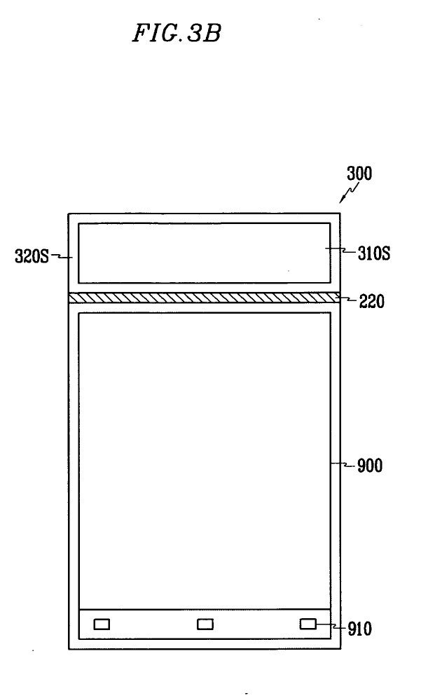

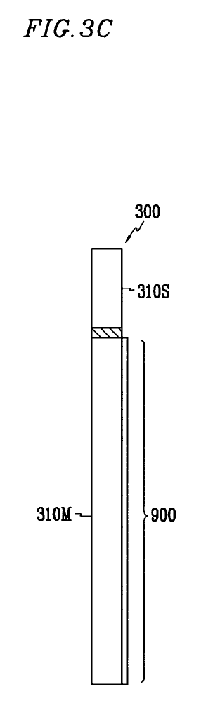

As shown in FIGS. 3A to 3C, a liquid crystal display according to an exemplary embodiment of the present invention is provided with a main display area 310M and a sub-display area 310S in one liquid crystal panel assembly 300. The two display areas 310M and 310S are divided by light blocking member 220, and black matrix regions 320M and 320S are positioned outside of display areas 310M and 310S, respectively.

An integrated chip 700 is positioned toward main display area 310M, and the backlight unit 900 is positioned toward sub-display area 310S and is disposed in only a rear side of main display area 310M.

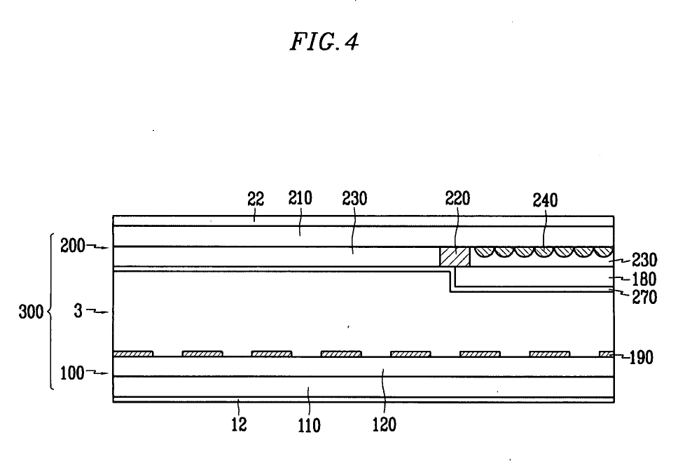

Referring to FIG. 4, substrate 110 is formed in lower panel 100 and a lower polarizer 12 is attached to the outside thereof.

A conductor layer 120 is formed on the substrate 110. Gate lines G₁ to Gₙ, data lines D₁ to Dₘ, and a switching element Q are formed in conductor layer 120. Pixel electrode 191 is formed on conductor layer 120 and is cut away in those regions where gate lines G₁ to G. or the data lines D₁ to Dₘ pass.

Substrate 210 is also formed in upper panel 200, and an upper polarizer 22 is attached to its outside. A color filter 230, a light blocking member 220, and a reflection layer 240 are formed on substrate 210. At this time, the reflection layer 240 is first formed in sub-display area 310S and the color filter 230 is formed thereon.

The light blocking member 220 divides two display areas 310M and 3108 and prevents light from the backlight unit 900 from leaking to sub-display area 310S.

Reflection layer 240, which is formed having a protruding shape such as by embossing, improves visibility by reflecting light from the outside in all directions.

A passivation layer 180 is formed on color filter 230 of sub-display panel 310S. Passivation layer 180 changes the cell gaps in the main display area 310M and sub-display area 310S. Common electrode 270 is formed on passivation layer 180 and the areas of color filter 230 not covered by passivation layer 180.

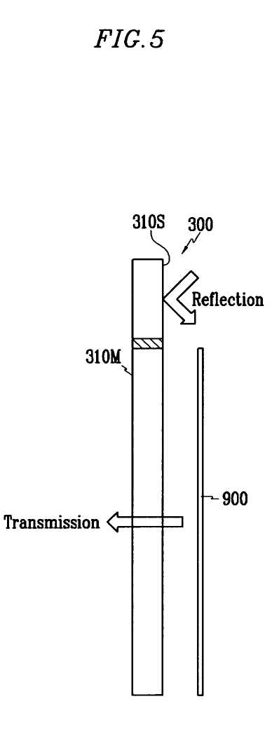

Referring to FIG.5, light from the backlight unit 900 positioned on the rear side of main display area 310M is made visible after passing through main display area 310M. Light that is incident upon sub-display area 310S is seen by reflecting from reflection layer 240. Accordingly, display area 31OM utilizes the transmission mode of light while sub-display area 310S uses the reflection mode of light. Accordingly, sub-display area 310S is positioned at the rear side while main display area 310M is positioned at the front side so that their display directions are opposite to each other.

A front light (not shown) in contrast to backlight 900 may be provided at a front side of sub-display area 310S for use when outside light is insufficient.

Liquid crystal layer 3 should exhibit characteristics suitable for both transmission and reflection modes, and the liquid crystals can be used in a voltage control birefringence ECB mode or a vertical alignment VA mode.

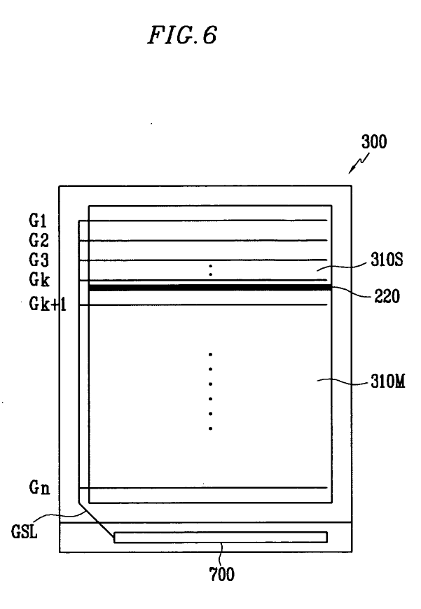

Furthermore, because one of polarizers 12 and 22 is in a transmission mode and the other is in a reflection mode, a transflective polarizer that can satisfy both conditions is preferred. For example, where a liquid crystal display is a folder type of mobile phone, only a main display area 310M may be operated when the folder is opened and only a sub-display area 310M may be operated when the folder is closed. As shown in FIG. 6, such an operation is, for example, performed as follows: since some of gate lines G₁ to Gₙ are positioned in main display area 310M and others are positioned in sub-display area 310S, a gate voltage is applied to only gate lines that are positioned in main display area 310M when the folder is opened and a gate voltage is applied to only gate lines that are positioned in sub-display area 310S when the folder is closed.

Referring again to FIG. 1, a gray voltage generator 800 generates two sets of gray voltages related to transmittance of a pixel. One of two sets has a positive value for the common voltage Vcom and the other has a negative value.

Gate driver 400 is connected to gate lines G. to Gₙ of liquid crystal panel assembly 300 to apply a gate signal consisting of the combination of a gate-on voltage Von and a gate-off voltage Voff to gate lines G₁ to Gₙ.

Data driver 500 is connected to data lines D₁ to Dₘ of liquid crystal panel assembly 300 to apply a gray voltage as a data signal to a pixel by selecting the gray voltage from gray voltage generator 800. Signal controller 600 includes a memory 650 that stores image data R, G, and B, and controls the operation of gate driver 400, data driver 500, etc. Chip 700 may include gate driver 400, data driver 500, signal controller 600, gray voltage generator 800, etc.

The operation of the liquid crystal display will be described in detail. Signal controller 600 receives input image signals R, G, and B from an external graphics controller (not shown) and an input control signal that includes, for example, a vertical synchronization signal Vsync, a horizontal synchronizing signal Hsync, a main clock signal MCLK, and a data enable signal DE.

Signal controller 600 appropriately processes the input image signals R, G, and B, based on the input image signals R, G, and B and the input control signal, and generates a gate control signal CONT1, a data control signal CONT2, etc. Controller 600 sends the gate control signal CONT1 to the gate driver 400 and sends the data control signal CONT2 and the processed image signal DAT to data driver 500.

The gate control signal CONT1 includes a scanning start signal STV to start scanning and at least one clock signal forf controlling the output period of the gate-on voltage Von. Gate control signal CONT1 may further include an output enable signal OE for limiting a duration time of the gate-on voltage Von.

Data control signal CONT2 includes a horizontal synchronization start signal STH for starting the application of image data for one row (set) of pixel PX and a load signal LOAD and a data clock signal HCLK for applying a data signal to the data lines D₁ to Dₘ. Data control signal CONT2 may further include an inversion signal RVS for inverting the voltage polarity of a data signal for a common voltage Vcom (hereinafter, “voltage polarity of a data signal for a common voltage” is briefly referred to as a “polarity of a data signal”).

As data driver 500 receives digital image signals DAT for one row (set) of pixels PX and selects a gray voltage corresponding to each digital image signal DAT, depending on the data control signal CONT2 from the signal controller 600, the digital image signal DAT is converted to an analog data signal and then the signal is applied to corresponding data lines D₁ to Dₘ.

Gate driver 400 turns on switching element Q that is connected to gate lines G₁ to Gₙ by applying the gate-on voltage Von to gate lines G₁ to Gₙ depending on the gate control signal CONT1 from tsignal controller 600. Then, a data signal that is applied to the data lines D₁ to Dₘ is applied to a corresponding pixel PX through the turned-on switching element Q.

The difference between the common voltage Vcom and the voltage of the data signal is applied to charge liquid crystal capacitor Clc. Liquid crystal molecules change their arrangement depending on the magnitude of the pixel voltage, changing the polarization of the light passing through the liquid crystal layer 3 and hence the transmittance of light through display panel assembly 300.

By repeating the process each horizontal period (referred to as “1H”, the same as one period of a horizontal synchronizing signal Hsync and a data enable signal DE), the gate-on voltage Von is sequentially applied to all gate lines G₁ to Gₙ, whereby the data signal is applied to all pixels PX to display one frame of the image signal.

The state of the frame inversion signal RVS that is applied to the data driver 500 is controlled so that a next frame starts when one frame ends, and so that the polarity of the data signal that is applied to each pixel PX is opposite to the polarity in the previous frame. According to characteristics of the inversion signal RVS even within one frame, the polarity of a data signal flowing through one data line may be changed (e.g., row inversion and dot inversion) or the polarity of the data signals that are applied to one pixel row may be different from each other (e.g., column inversion, dot inversion).

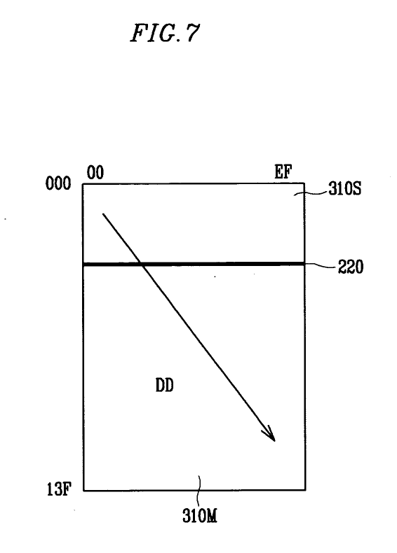

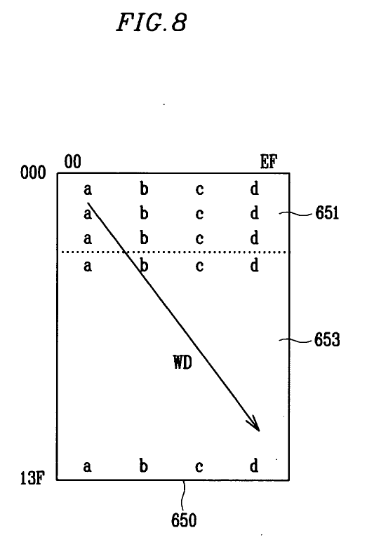

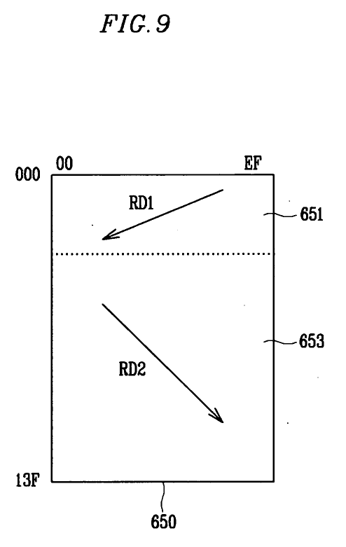

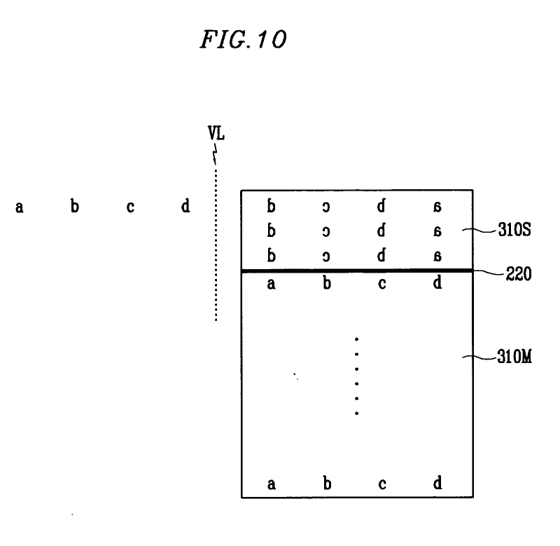

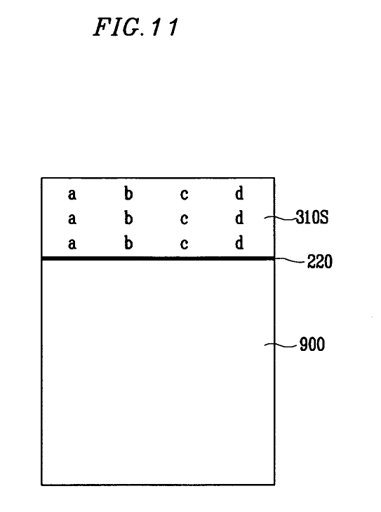

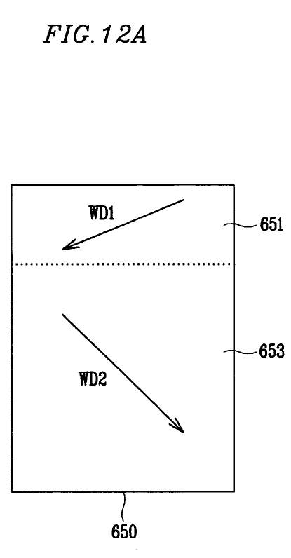

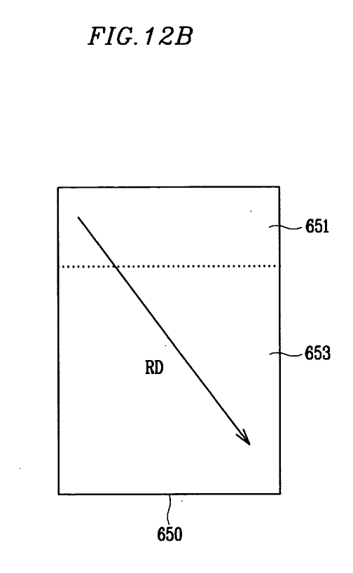

A method of driving the liquid crystal display according to an exemplary embodiment of the present invention will be described in detail with reference to FIGS. 6 and 7 to 12B. FIG. 7 is a view illustrating a display direction in the liquid crystal display according to an exemplary embodiment of the present invention, FIG. 8 is a view illustrating a write direction in a memory of the liquid crystal display according to an exemplary embodiment of the present invention, and FIG. 9 is a view illustrating a read direction in a memory of the liquid crystal display according to an exemplary embodiment of the present invention. FIG. 10 is a view illustrating an image that is displayed in the liquid crystal display according to an exemplary embodiment of the present invention, and FIG. 11 is a view illustrating an image that is displayed in a sub-display area of the liquid crystal display in the images that are shown in FIG. 10. FIGS. 12A and 12B are views illustrating a read direction and a write direction in a memory of a liquid crystal display according to another exemplary embodiment of the present invention.

Referring to FIG. 6, lines G₁ to Gₖ of gate lines G₁ to Gₙ are disposed in sub-display area 310S,and lines Gₖ₊₁ to Gₙ are disposed in main display area 310M. Gate voltages Von and Voff, which are generated in chip 700, are sequentially applied to gate lines G₁ to Gₙ through gate voltage line GSL. The gate voltages are applied by chip 700 in order from gate line Gₙ to gate line G₁. Accordingly, as shown in FIG. 7, an image is displayed in the two display panels 310M and 310S in a display direction DD that is indicated by the arrow.

FIG. 8 shows the data write direction WD in memory 650 for storing the image data (hereinafter, referred to as the “source image”) comprising characters such as a, b, c, and d.

Here, for better comprehension and ease of description, the hexadecimals “00”, “EF”, “000”, and “13F” shown at the edges of the display areas corresponding to a resolution of 240×320.

As shown in FIG. 9, data read directions RD1 and RD2 are different from each other in first region 651 and second region 653 of memory 650. That is, in the first region, data are read in a direction of right-up-left-down and, in the second region, data are read in a direction of left-up-right-down, which is the same direction as the write direction.

Specifically, in the first region 651, data that are input on one row basis are output in a last-in-first-out manner, and in the second region 653 the data are output in a first-in-first-out manner. For example, data a, b, c, and d of a first row are input in memory 650 in the order of a, b, c, and d, and are output from memory 650 in the opposite order of d, c, b, and a.

Similarly, as described in FIGS. 12A and 12B, in the first region 651, the read direction RD and the write direction WD1 are opposite to the direction that is shown in FIGS. 8 and 9, but the output is performed in the same manner as the last-in-first-out manner.

Accordingly, the main image that is displayed in main display area 31OM is equal to the source image, but the subsidiary image that is displayed in sub-display area 310S is in mirror symmetry with the source image about an imaginary line VL. However, the image is displayed in an inversion format because it is seen from the front surface, and the image that is displayed as a source image as shown in FIG. 11 is not in an inversion format.

On the other hand, in exemplary embodiments according to the present invention, although it is described that chip 700 includes gate driver 400, the present invention can even be applied to a case where the gate driver 400 is integrated into the liquid crystal panel assembly 300.

As described above, a space of the memory 650 is divided into two regions, one of them is allocated as a space for sub-display area 310S, and in a space for sub-display area 310S, a write direction and a read direction are different from each other, whereby a source image is displayed even in a rear surface.

In this way, an image that is displayed in particularly sub-display area 310S among main display area 310M and sub-display area 310S that are formed on one substrate can be displayed in a source format rather than an inversion format. While this invention has been described in connection with what is presently considered to be practical exemplary embodiments, it is to be understood that the invention is not limited to the disclosed embodiments but, on the contrary, is intended to cover various modifications and equivalent arrangements that will be apparent to those skilled in the art, without however, departing from the spirit and scope of the invention.

What is claimed is:

1. A liquid crystal display comprising:
a liquid crystal panel assembly having a first display area and a second display area positioned opposite each other; and
a memory that stores rows of image data, said memory having a first region for storing data to be displayed in the first display area and a second region for storing data to be displayed in the second display area, said memory outputting to said first display from said first region a row of data that have been last stored in said first region, and outputting to said second display area from said second region a row of data that have been first stored in said second region.

2. The liquid crystal display of claim 1, wherein the liquid crystal panel assembly further comprises a plurality of gate lines that transfer a gate signal.

3. The liquid crystal display of claim 2, wherein a part of the gate line is positioned in the first display area and the other part is positioned in the second display area.

4. The liquid crystal display of claim 3, wherein the gate signal is first applied to the gate line that is positioned in the first display area.

5. The liquid crystal display of claim 4, further comprising a backlight unit that is positioned in the same direction as the first display area and is positioned in a rear side of the second display area to provide light.

6. The liquid crystal display of claim 5, wherein the liquid crystal panel assembly comprises a first display panel, a second display panel, and a liquid crystal layer therebetween, wherein
the first display panel comprises:
a first substrate;
a conductor layer that is formed on the first substrate; and
a pixel electrode that is formed on the conductor layer, and the second display panel comprises:
a second substrate;
a reflection layer and a light blocking member that are formed on the second substrate;
a color filter that is formed on the reflection layer or the second substrate;
a passivation layer that is formed on the color filter; and
a common electrode that is formed on passivation layer and the color filter that is not covered with passivation layer.

7. The liquid crystal display of claim 6, wherein the reflection layer is formed in the first display area.

8. The liquid crystal display of claim 7, wherein an interval of a liquid crystal layer in the first display area is different from that of a liquid crystal layer in the second display area.

9. The liquid crystal display of claim 8, further comprising a driving chip for driving the first and second display areas.

10. The liquid crystal display of claim 9, wherein the driving chip comprises the gate driver and the memory.

11. A driving method of a liquid crystal display comprising a liquid crystal panel assembly that is provided with a first display area and a second display area that are positioned at opposite sides to each other, and a memory that stores image data from the outside in a matrix shape,
wherein the memory comprises a first region for storing data that are displayed in the first display area and a second region for storing data that are displayed in the second display area, among the image data, the method comprising:
writing the image data in the memory;
first outputting data that are last input in one row unit among the data that are stored in the first region; and
first outputting data that are first input among the data that are stored in the second region.

12. The driving method of claim 11, wherein the liquid crystal panel assembly further comprises a plurality of gate lines that transfer a gate signal.

13. The driving method of claim 12, wherein a part of the gate line is positioned in the first display area and the other part is positioned in the second display area.

14. The driving method of claim 13, wherein the gate signal is first applied to the gate line that is positioned in the first display area.

15. The driving method of claim 14, further comprising a backlight unit that is positioned in the same direction as the first display area and is positioned in a rear side of the second display area to provide light.

16. The driving method of claim 15, wherein the liquid crystal panel assembly comprises a first display panel, a second display panel, and a liquid crystal layer therebetween, wherein the first display panel comprises:
a first substrate;
a conductor layer that is formed on the first substrate; and
a pixel electrode that is formed on the conductor layer, and the second display panel comprises:
a second substrate;
a reflection layer and a light blocking member that are formed on the second substrate;
a color filter that is formed on the reflection layer or the second substrate;
a passivation layer that is formed on the color filter; and
a common electrode that is formed on passivation layer and the color filter that is not covered with passivation layer.

17. The driving method of claim 16, wherein the reflection layer is formed in the first display area.

18. The driving method of claim 17, wherein an interval of a liquid crystal layer in the first display area is different from that of a liquid crystal layer in the second display area.

19. The driving method of claim 18, wherein further comprising a driving chip for driving the first and second display areas.

20. The driving method of claim 19, wherein the driving chip comprises the gate driver and the memory.
